(19) United States
(12) Patent Application Publication
(10) Pub. No.: US 2023/0077690 A1
(43) Pub. Date: Mar. 16, 2023

(54) IMAGE PROCESSING DEVICE, IMAGE PROCESSING METHOD, AND PROGRAM

(71) Applicant: FUJIFILM Corporation, Tokyo (JP)

(72) Inventor: Takuya TSUTAOKA, Kanagawa (JP)

(73) Assignee: FUJIFILM Corporation, Tokyo (JP)

(21) Appl. No.: 17/931,526

(22) Filed: Sep. 12, 2022

(30) Foreign Application Priority Data
Sep. 13, 2021 (JP) 2021-148846

(51) Int. Cl. G06V 10/774; G06V 10/772; G06T 7/00

(52) U.S. Cl. CPC G06V 10/774; G06T 7/0012; G06V 10/772; G06T 2207/20081; G06T 2207/30096

(57) ABSTRACT

There are provided an image processing device, an image processing method, and a program that can efficiently obtain learning data allowing effective machine learning to be expected.

An image processing device includes a processor and a plurality of recognizers, and the processor acquires a video acquired by a medical apparatus, causes the plurality of recognizers to perform processing for recognizing a lesion in image frames forming the video to acquire a recognition result of each of the plurality of recognizers, and determines whether or not to use the image frame as learning data to be used for machine learning on the basis of the recognition result of each of the plurality of recognizers.

### CROSS-REFERENCE TO RELATED APPLICATION

The present application claims priority under 35 U.S.C §119(a) to Japanese Patent Application No. 2021-148846 filed on Sep. 13, 2021, which is hereby expressly incorporated by reference, in its entirety, into the present application.

### BACKGROUND OF THE INVENTION

### 1. Field of the Invention

The present invention relates to an image processing device, an image processing method, and a program, and more particularly, to an image processing device, an image processing method, and a program that determine learning data used for machine learning.

### 2. Description of the Related Art

In recent years, in a medical field, the image of an object to be examined has been used for the detection and the like of lesions to assist medical doctor’s diagnosis and the like.

For example, JP2010-504129A (JP-H22-504129A) discloses a technique that receives a plurality of medical data (image data and clinical data) as inputs and outputs a diagnosis based on the data.

### SUMMARY OF THE INVENTION

Here, in a case where a lesion is to be detected from an image, artificial intelligence (AI: learning model) is subjected to machine learning using learning data and teacher data to complete trained AI (trained model) and this trained AI is used to detect a lesion. Learning data used for the machine learning of AI are one of factors that determine the performance of AI. In a case where machine learning is performed using learning data that allow effective machine learning to be performed, the improvement of the performance of AI effective with respect to the amount of learning can be expected.

On the other hand, even in a case where the same image is input to plurality of AIs, the output results of the respective AIs may vary. Such an image is an image that is difficult to be determined, detected, or the like by AI, and is excellent as learning data. In a case where AI is subjected to machine learning using such excellent learning data, the performance of AI can be effectively improved.

The present invention has been made in consideration of the above-mentioned circumstances, and an object of the present invention is to provide an image processing device, an image processing method, and a program that can efficiently obtain learning data allowing effective machine learning to be expected.

In order to achieve the object, an image processing device according to an aspect of the present invention is an image processing device comprising a processor and a plurality of recognizers, and the processor acquires a video acquired by a medical apparatus, causes the plurality of recognizers to perform processing for recognizing a lesion in image frames forming the video to acquire a recognition result of each of the plurality of recognizers, and determines whether or not to use the image frame as learning data to be used for machine learning on the basis of the recognition result of each of the plurality of recognizers.

According to this aspect, an image frame is input to the plurality of recognizers and whether or not to use the image frame as learning data to be used for machine learning is determined on the basis of the recognition results of the plurality of recognizers. Accordingly, learning data allowing effective machine learning to be performed can be efficiently obtained in this aspect.

Preferably, the plurality of recognizers differ in terms of at least one of a structure, a type, or a parameter of the recognizer.

Preferably, the plurality of recognizers are subjected to learning using different learning data, respectively.

Preferably, the plurality of recognizers are subjected to machine learning using the different learning data that are obtained from different medical devices, respectively.

Preferably, the plurality of recognizers are subjected to machine learning using the different learning data obtained from facilities of different countries or regions, respectively.

Preferably, the plurality of recognizers are subjected to machine learning using the different learning data obtained under different image pickup conditions, respectively.

Preferably, in a case where the processor determines an image frame to which a diagnosis result is given as learning data, the processor generates teacher labels of the learning data on the basis of the diagnosis result.

Preferably, a learning model, which performs the machine learning, is subjected to learning using the learning data determined by the processor.

Preferably, the processor causes the learning model to learn the learning data with sample weights that are determined on the basis of distribution of the recognition results of the plurality of recognizers.

Preferably, the processor generates teacher labels of the machine learning on the basis of distribution of the recognition results.

Preferably, the processor changes sample weights for the machine learning according to magnitudes of variations of the recognition results.

Preferably, the processor causes the plurality of recognizers to perform processing for recognizing a lesion in the consecutive time-series image frames to acquire the recognition results of each of the plurality of recognizers, and determines whether or not to use the image frames for the machine learning on the basis of the consecutive time-series recognition results of each of the plurality of recognizers.

Preferably, at least one recognizer of the plurality of recognizers outputs the recognition result during acquisition of the video and the other recognizers output the recognition results when a first time has passed from acquisition of the video.

An image processing method according to another aspect of the present invention is an image processing method of an image processing device including a processor and a plurality of recognizers; and the processor performs a step of acquiring a video acquired by a medical apparatus, a step of causing the plurality of recognizers to perform processing for recognizing a lesion in image frames forming the video to acquire a recognition result of each of the plurality of recognizers, and a step of determining whether or not to use the image frame as learning data to be used for machine learning on the basis of the recognition result of each of the plurality of recognizers.

A program according to still another aspect of the present invention is a program causing an image processing device, which includes a processor and a plurality of recognizers, to perform an image processing method; and the program causes the processor to perform a step of acquiring a video acquired by a medical apparatus, a step of causing the plurality of recognizers to perform processing for recognizing a lesion in image frames forming the video to acquire a recognition result of each of the plurality of recognizers, and a step of determining whether or not to use the image frame as learning data to be used for machine learning on the basis of the recognition result of each of the plurality of recognizers.

According to the present invention, since an image frame is input to the plurality of recognizers and whether or not to use the image frame as learning data to be used for machine learning is determined on the basis of the recognition results of the plurality of recognizers, learning data allowing effective machine learning to be performed can be efficiently obtained.

### BRIEF DESCRIPTION OF THE DRAWINGS

FIG. 1 is a block diagram showing the main configuration of an image processing device.

FIG. 2 is a diagram conceptually showing an examination video.

FIG. 3 is a diagram showing an example of a recognition unit.

FIG. 4 is a diagram illustrating the determination of whether or not image frames are used as learning data to be used for the machine learning of a learning availability determination unit.

FIG. 5 is a flowchart showing an image processing method that is performed using the image processing device.

FIG. 6 is a block diagram showing the main configuration of an image processing device.

FIG. 7 is a diagram illustrating a learning availability determination unit and a first teacher label generation unit.

FIG. 8 is a diagram illustrating a case where the first teacher label generation unit generates teacher labels.

FIG. 9 is a functional block diagram showing the main functions of a learning controller and a learning model.

FIG. 10 is a block diagram showing the main configuration of an image processing device.

FIG. 11 is a diagram illustrating a learning availability determination unit and a second teacher label generation unit.

FIG. 12 is a diagram showing a case where an image frame is input to a recognition unit.

FIG. 13 is a diagram showing a modification example of the recognition unit.

FIG. 14 is a diagram illustrating a modification example of the learning availability determination unit.

FIG. 15 is a diagram illustrating overall configuration of an endoscope apparatus.

FIG. 16 is a functional block diagram of the endoscope apparatus.

### DESCRIPTION OF THE PREFERRED EMBODIMENTS

An image processing device, an image processing method, and a program according to preferred embodiments of the present invention will be described below with reference to the accompanying drawings.

### First Embodiment

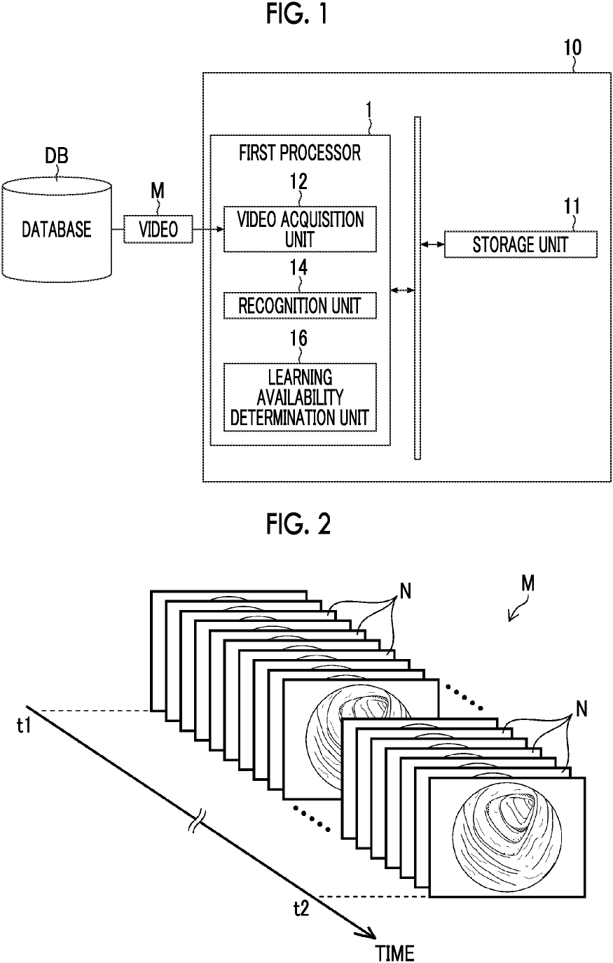

FIG. 1 is a block diagram showing the main configuration of an image processing device 10 according to this embodiment.

The image processing device 10 is mounted on, for example, a computer. The image processing device 10 mainly comprises a first processor (processor) 1 and a storage unit 11. The first processor 1 is formed of a central processing unit (CPU) or a graphics processing unit (GPU) that is mounted on the computer. The storage unit 11 is formed of a read only memory (ROM) and a random access memory (RAM) that are mounted on the computer.

The first processor 1 realizes various functions by executing a program stored in the storage unit 11. The first processor 1 functions as a video acquisition unit 12, a recognition unit 14, and a learning availability determination unit 16.

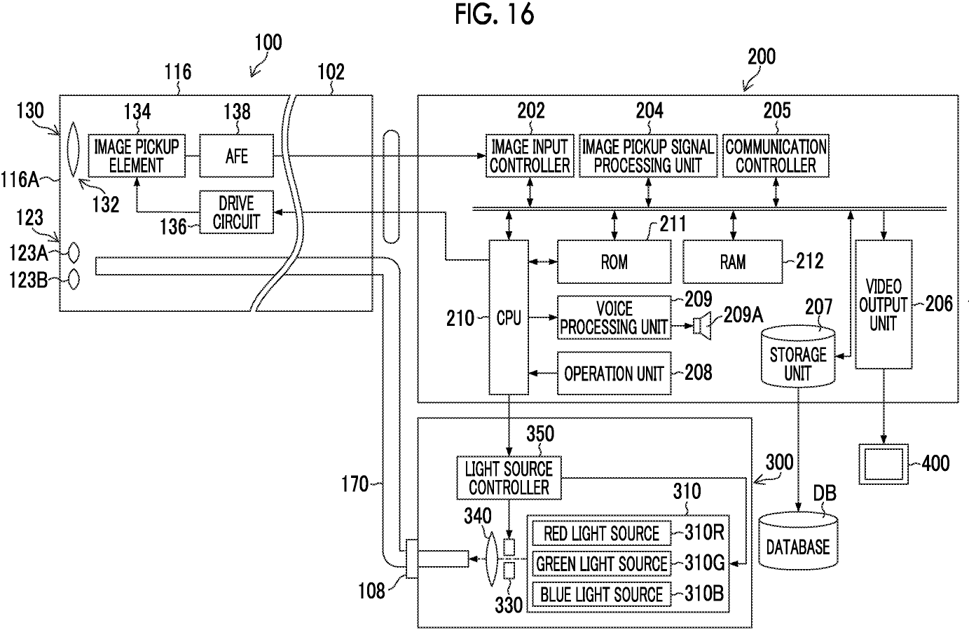

The video acquisition unit 12 acquires an examination video (video) M, which is picked up by an endoscope apparatus 500 (see FIGS. 15 and 16), from a database DB. The endoscope apparatus 500 is an example of a medical apparatus and the examination video M is an example of a video. The video acquisition unit 12 can acquire videos, which are acquired by a medical apparatus, in addition to the above-mentioned examination video M. The examination video M is input via a data input unit of the computer that forms the image processing device 10, and the video acquisition unit 12 acquires the input examination video M.

FIG. 2 is a diagram conceptually showing the examination video M that is acquired by the video acquisition unit 12. The examination video M is an examination video in which the large intestine is examined by a lower endoscope apparatus.

As shown in FIG. 2, the examination video M is a video related to an examination that is performed between a time point t1 and a time point t2. The examination video M is formed of a plurality of consecutive time-series image frames N, and each image frame N has information about a time point when the video is picked up. The image frame N includes the image of the large intestine, which is a body to be examined, picked up in a case where lower endoscopy is performed. The examination video M picked up in lower endoscopy is described in this embodiment, but an examination video is not limited thereto. For example, the technique of the present disclosure is also applied to an examination video picked up in upper endoscopy.

The recognition unit 14 (FIG. 1) performs processing for recognizing a lesion in the image frames N forming the examination video M that is acquired by the video acquisition unit 12. The recognition unit 14 is formed of a plurality of recognizers, and causes the plurality of recognizers to perform processing for recognizing a lesion on each input image frame and to output recognition results. Then, the recognition unit 14 acquires the recognition result of each of the plurality of recognizers. Each of the recognizers is a trained model that has been subjected to machine learning in advance. Further, it is preferable that the plurality of recognizers have variety. Here, having variety means that the tendency of strength or weakness in recognizing a lesion differs and the entropy of an output is large in a case where the same image frame N is input. For example, the plurality of recognizers may be subjected to machine learning using different learning data, respectively. Further, for example, the plurality of recognizers may be subjected to machine learning using different learning data that are obtained from different medical devices, respectively. Different learning data are learning data that are obtained from the same type but different medical devices (differences in facilities) or different types of medical devices (differences in endoscope models, or the like). Furthermore, for example, the plurality of recognizers may be subjected to machine learning using different learning data obtained from facilities of different countries or regions, respectively. Moreover, for example, the plurality of recognizers may be subjected to machine learning using different learning data obtained under different image pickup conditions, respectively. Here, image pickup information is resolution, an exposure time, white balance, a frame rate, and the like. As described above, the plurality of recognizers of the recognition unit 14 have the above-mentioned variety. Accordingly, it is possible to prevent the recognition results, which are obtained from the plurality of recognizers, from being always uniform.

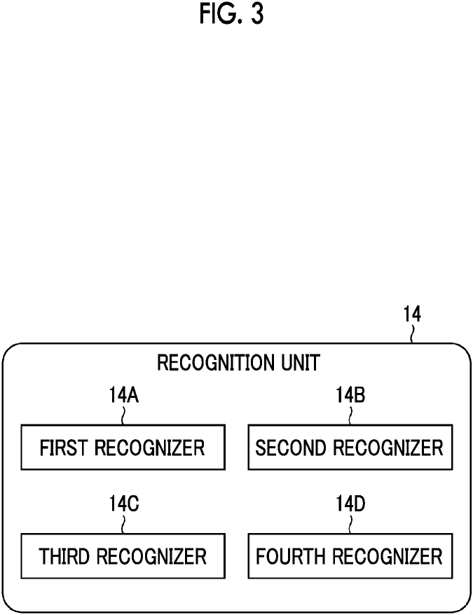

FIG. 3 is a diagram showing an example of the recognition unit 14.

As shown in FIG. 3, the recognition unit 14 includes a first recognizer (recognizer) 14A, a second recognizer (recognizer) 14B, a third recognizer (recognizer) 14C, and a fourth recognizer (recognizer) 14D. The first to fourth recognizers 14A to 14D are formed of trained models that have been subjected to machine learning in advance.

For example, the first to fourth recognizers 14A to 14D are subjected to machine learning using learning data acquired from different facilities or hospitals, respectively. Specifically, the first recognizer 14A is subjected to machine learning using learning data acquired at a hospital A, the second recognizer 14B is subjected to machine learning using learning data acquired at a hospital B, the third recognizer 14C is subjected to machine learning using learning data acquired at a hospital C, and the fourth recognizer 14D is subjected to machine learning using learning data acquired at a hospital D.

Generally, the tendency of an examination video, such as image quality preferred in a case where an examination video is picked up, may differ depending on facilities or hospitals. Accordingly, since the first to fourth recognizers 14A to 14D are subjected to machine learning as described above using learning data acquired from different facilities or hospitals, respectively, the recognition unit 14 having variety in the tendency of an examination video (the image quality or the like of an examination video) can be formed.

The first to fourth recognizers 14A to 14D may be subjected to machine learning using learning data of which the distribution of facilities or hospitals, which forms learning data, is biased. For example, the learning data used for the machine learning of the first recognizer 14A are formed of 50% of the data acquired at the hospital A, 25% of the data acquired at the hospital B, 20% of the data acquired at the hospital C, and 5% of the data acquired at the hospital D. The learning data used for the machine learning of the second recognizer 14B are formed of 5% of the data acquired at the hospital A, 50% of the data acquired at the hospital B, 25% of the data acquired at the hospital C, and 20% of the data acquired at the hospital D. The learning data used for the machine learning of the third recognizer 14C are formed of 20% of the data acquired at the hospital A, 5% of the data acquired at the hospital B, 50% of the data acquired at the hospital C, and 25% of the data acquired at the hospital D. The learning data used for the machine learning of the fourth recognizer 14D are formed of 25% of the data acquired at the hospital A, 20% of the data acquired at the hospital B, 5% of the data acquired at the hospital C, and 50% of the data acquired at the hospital D.

Further, for example, the first to fourth recognizers 14A to 14D may be subjected to machine learning using data acquired in different countries or regions, respectively. Specifically, the first recognizer 14A is subjected to machine learning using learning data acquired in the United States of America, the second recognizer 14B is subjected to machine learning using learning data acquired in the Federal Republic of Germany, the third recognizer 14C is subjected to machine learning using learning data acquired in the People’s Republic of China, and the fourth recognizer 14D is subjected to machine learning using learning data acquired in Japan.

The technique (method) of endoscopy may differ depending on countries or regions. For example, since there are many residues in Europe, the technique of endoscopy in Europe is often different from that in Japan. Accordingly, the first to fourth recognizers 14A to 14D are subjected to machine learning using learning data acquired in different countries or regions as described above, respectively, so that the recognition unit 14 having variety in the technique (method) of endoscopy can be formed.

The first to fourth recognizers 14A to 14D may be subjected to machine learning using learning data of which the distribution of countries or regions is biased. For example, the learning data used for the machine learning of the first recognizer 14A are formed of 50% of the data acquired in the United States of America, 25% of the data acquired in the Federal Republic of Germany, 20% of the data acquired in the People’s Republic of China, and 5% of the data acquired in Japan. The learning data used for the machine learning of the second recognizer 14B are formed of 5% of the data acquired in the United States of America, 50% of the data acquired in the Federal Republic of Germany, 25% of the data acquired in the People’s Republic of China, and 20% of the data acquired in Japan. The learning data used for the machine learning of the third recognizer 14C are formed of 20% of the data acquired in the United States of America, 5% of the data acquired in the Federal Republic of Germany, 50% of the data acquired in the People’s Republic of China, and 25% of the data acquired in Japan. The learning data used for the machine learning of the fourth recognizer 14D are formed of 25% of the data acquired in the United States of America, 20% of the data acquired in the Federal Republic of Germany, 5% of the data acquired in the People’s Republic of China, and 50% of the data acquired in Japan.

Further, for example, the first to fourth recognizers 14A to 14D may be formed to have different sizes. For example, the first recognizer 14A is formed of a recognizer that can be operated while a video is acquired by the endoscope apparatus 500 (immediately after a video is acquired: in real time). Specifically, the image frames N forming the examination video M are continuously input to the first recognizer 14A and the first recognizer 14A outputs a recognition result immediately after each image frame N is input. Further, the second recognizer 14B is formed of a recognizer having a processing capacity of 3 FPS (Film per Second), the third recognizer 14C is formed of a recognizer having a processing capacity of 5 FPS, and the fourth recognizer 14D is formed of a recognizer having a processing capacity of 10 FPS. Each of the second recognizer 14B, the third recognizer 14C, and the fourth recognizer 14D outputs a recognition result when a first time has passed from the acquisition of a video. Here, the first time is a time that is determined depending on the processing capacity of each of the second recognizer 14B, the third recognizer 14C, and the fourth recognizer 14D. Since the sizes of the first to fourth recognizers 14A to 14D are made different as described above, an image frame N, which could not be recognized well by the recognizer that can be operated while a video is acquired (actually, a recognizer handled by a user), can be employed as learning data.

The learning availability determination unit 16 (FIG. 1) determines whether or not to use an image frame N, which is input to the recognition unit 14, as learning data to be used for machine learning on the basis of the recognition result of each of the plurality of recognizers acquired by the recognition unit 14.

The learning availability determination unit 16 determines whether or not to use an image frame N as learning data to be used for machine learning by various methods. For example, in a case where not all the recognition results of the recognizers of the recognition unit 14 match, the learning availability determination unit 16 determines an image frame N as learning data to be used for machine learning. In a case where all the recognition results match, the learning availability determination unit 16 determines an image frame N as learning data not to be used for machine learning. Since an image frame N of which the recognition results match in the plurality of recognizers is so-called simple learning data, the higher effect of machine learning cannot be expected even if machine learning is performed using this learning data. Accordingly, the learning availability determination unit 16 determines that an image frame N of which all the recognition results match in the plurality of recognizers is not used as learning data. On the other hand, since an image frame N of which not all the recognition results match in the plurality of recognizers is learning data difficult to be recognized, effective performance improvement can be expected in a case where machine learning is performed. Accordingly, the learning availability determination unit 16 determines that an image frame N of which not all the recognition results match in the plurality of recognizers is used as learning data.

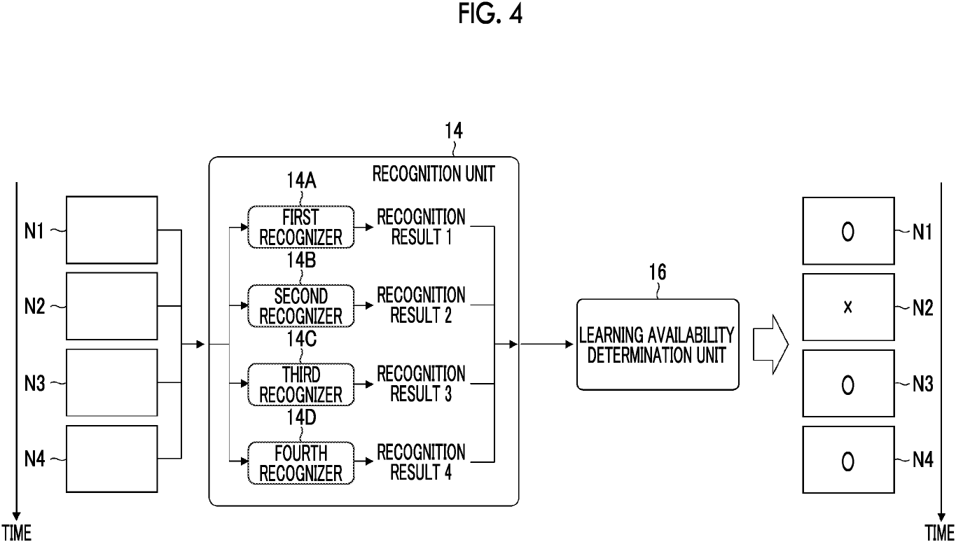

FIG. 4 is a diagram illustrating the determination of whether or not image frames are used as learning data to be used for the machine learning of the learning availability determination unit 16.

Consecutive time-series image frames N1 to N4, which are some sections of the examination video M, are sequentially input to the recognition unit 14.

The first to fourth recognizers 14A to 14D of the recognition unit 14 output recognition results 1 to 4 for the input image frames N1 to N4.

In a case where the image frame N1 is input, the first to fourth recognizers 14A to 14D output recognition results 1 to 4, respectively. Only the recognition result 1 among the output recognition results 1 to 4 is different from the other recognition results (the recognition results 2 to 4). Accordingly, since not all the recognition results match, the learning availability determination unit 16 determines that the image frame N1 is used as learning data for machine learning (in FIG. 4, “◯” is given to the image frame N1).

In a case where the image frame N2 is input, the first to fourth recognizers 14A to 14D output recognition results 1 to 4, respectively. All the output recognition results 1 to 4 match. Accordingly, since all the recognition results match, the learning availability determination unit 16 determines that the image frame N2 is not used as learning data for machine learning (in FIG. 4, “×” is given to the image frame N2).

Further, even in the cases of the image frames N3 and N4, as in the case of the image frame N1, only the recognition result 1 among recognition results 1 to 4 is different from the other recognition results (the recognition results 2 to 4). Accordingly, since not all the recognition results match, the learning availability determination unit 16 determines that the image frames N3 and N4 are used as learning data for machine learning (in FIG. 4, “◯” is given to the image frames N3 and N4).

As described above, in a case where all the recognition results 1 to 4 match, the learning availability determination unit 16 determines that the image frame N is not used as learning data. In a case where not all the recognition results 1 to 4 match, the learning availability determination unit 16 determines that the image frame N is used as learning data.

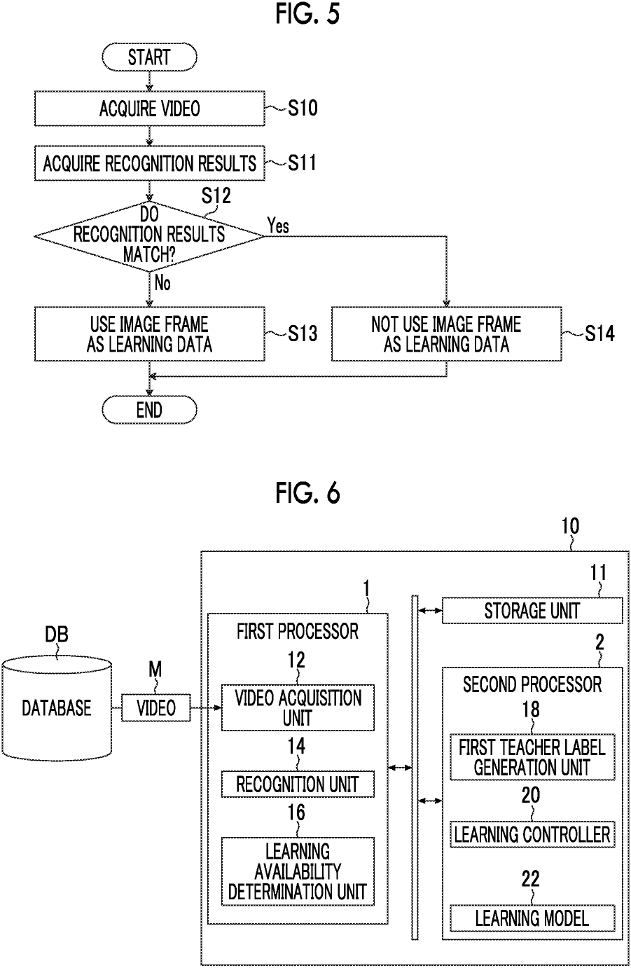

FIG. 5 is a flowchart showing an image processing method that is performed using the image processing device 10 according to this embodiment. The first processor 1 of the image processing device 10 executes a program stored in the storage unit 11, so that the image processing method is performed.

First, the video acquisition unit 12 acquires the examination video M (Step S10: video acquisition step). After that, the recognition unit 14 acquires the recognition results of the first recognizer 14A, the second recognizer 14B, the third recognizer 14C, and the fourth recognizer 14D (Step S11: result acquisition step). Then, the learning availability determination unit 16 determines whether or not all the recognition results 1 to 4 of the first recognizer 14A, the second recognizer 14B, the third recognizer 14C, and the fourth recognizer 14D match (Step S12: learning availability determination step). In a case where all the recognition results 1 to 4 match, the learning availability determination unit 16 determines that the image frame N is not used as learning data (Step S14). On the other hand, in a case where not all the recognition results 1 to 4 match, the learning availability determination unit 16 determines that the image frame N is used as learning data (Step S13).

According to this embodiment, as described above, the image frame N is input to the plurality of recognizers and whether or not to use the image frame N as learning data to be used for machine learning is determined on the basis of the recognition results of the plurality of recognizers. Accordingly, learning data allowing effective learning to be performed can be efficiently obtained in this embodiment.

### Second Embodiment

Next, a second embodiment of the present invention will be described. In this embodiment, learning data are determined and teacher labels of image frames N determined as the learning data are generated from a given diagnosis result.

FIG. 6 is a block diagram showing the main configuration of an image processing device 10 according to this embodiment. Components already described in FIG. 1 will be denoted by the same reference numerals as described above and the description thereof will be omitted.

The image processing device 10 mainly comprises a first processor 1, a second processor (processor) 2, and a storage unit 11. The first processor 1 and the second processor 2 may be formed of the same CPUs (or GPUs) or may be formed of different CPUs (or GPUs). The first processor 1 and the second processor 2 realize the respective functions shown in a functional block by executing a program stored in the storage unit 11.

The first processor 1 includes a video acquisition unit 12, a recognition unit 14, and a learning availability determination unit 16. The second processor (processor) 2 includes a first teacher label generation unit 18, a learning controller 20, and a learning model 22.

The first teacher label generation unit 18 generates teacher labels of image frames N on the basis of a given diagnosis result. Here, the diagnosis result is, for example, information that is given by a medical doctor or the like during endoscopy and is incidental to an image frame. For example, a medical doctor gives a diagnosis result, such as the presence or absence of a lesion, the type of lesion, or the degree of lesion. A medical doctor uses a hand operation unit 102 of the endoscope apparatus 500 to input the diagnosis result. The input diagnosis result is given as accessory information of the image frame N.

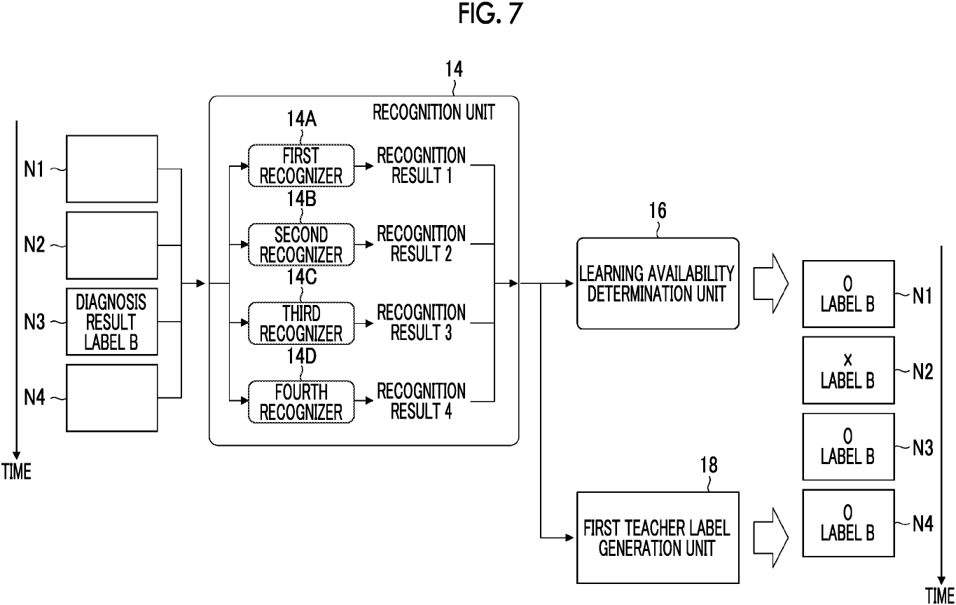

FIG. 7 is a diagram illustrating the learning availability determination unit 16 and the first teacher label generation unit 18. Components already described in FIG. 4 will be denoted by the same reference numerals as described above and the description thereof will be omitted.

Consecutive time-series image frames N1 to N4, which are some sections of the examination video M, are sequentially input to the recognition unit 14. A diagnosis result (label B) is given to the image frame N3.

In a case where the image frame N1, the image frame N3, and the image frame N4 are input, the first to fourth recognizers 14A to 14D output recognition results 1 to 4, respectively, and only the recognition result 1 among the output recognition results 1 to 4 is different from the other recognition results (the recognition results 2 to 4). Accordingly, since not all the recognition results match, the learning availability determination unit 16 determines that the image frame N1, the image frame N3, and the image frame N4 are used as learning data for machine learning (in FIG. 7, “◯” is given to the image frame N1, the image frame N3, and the image frame N4).

On the other hand, in a case where the image frame N2 is input, the first to fourth recognizers 14A to 14D output recognition results 1 to 4, respectively, and all the output recognition results 1 to 4 match. Accordingly, since all the recognition results match, the learning availability determination unit 16 determines that the image frame N2 is not used as learning data for machine learning (in FIG. 7, “×” is given to the image frame N2).

The first teacher label generation unit 18 generates teacher labels on the basis of the diagnosis result given to the image frame N3. Specifically, the first teacher label generation unit 18 generates the teacher labels of nearby image frames (for example, the image frames N1 to N4) on the basis of the diagnosis result (label B) given to the image frame N3. Accordingly, the teacher labels of the image frames N1 to N4 are labels B, and the label B is a teacher label in a case where any one of the image frames N1 to N4 is determined as learning data. The first teacher label generation unit 18 may give sample weights to teacher labels to be generated. For example, the first teacher label generation unit 18 generates teacher labels to which larger sample weights are given as the variation of the recognition results 1 to 4 is larger. Accordingly, machine learning can be focused on learning data (and a teacher label) that can be determined by a medical doctor but are difficult to be determined by a recognizer.

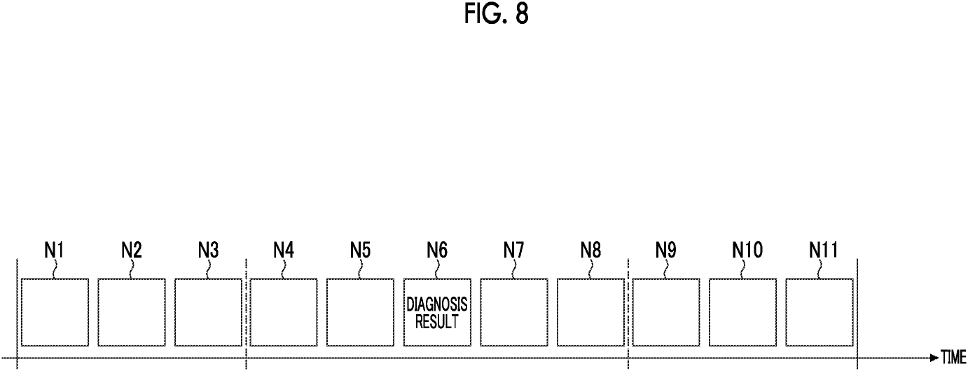

FIG. 8 is a diagram illustrating a case where the first teacher label generation unit 18 generates teacher labels.

The first teacher label generation unit 18 generates the teacher labels of nearby image frames on the basis of the given diagnosis result. Here, the range of “nearby” is a range that can be arbitrarily set by a user and can be changed depending on an object to be examined or the frame rate of the examination video M.

In a case where a diagnosis result is given to an image frame N6 as shown in FIG. 8, the first teacher label generation unit 18 generates the teacher labels of, for example, previous two frames and later two frames (image frames N4 to N8) on the basis of the diagnosis result given to the image frame N6. Further, the first teacher label generation unit 18 may generate the teacher labels of, for example, previous five frames and later five frames (image frames N1 to N11) on the basis of the diagnosis result given to the image frame N6. A sample weight may be given to the teacher label corresponding to each image frame. This sample weight may be given according to a temporal distance from the image frame N6 to which the diagnosis result is given. For example, the sample weights for the image frame N5 and the image frame N7 are set to be lower than those of the image frame N1 and the image frame N11.

The learning controller 20 causes the learning model 22 to perform machine learning. Specifically, the learning controller 20 inputs the image frames N, which are determined to be used as learning data by the learning availability determination unit 16, to the learning model 22 and causes the learning model 22 to perform learning. Further, the learning controller 20 acquires the teacher labels that are generated by the first teacher label generation unit 18; acquires errors between output results, which are output from the learning model 22, and the teacher labels; and updates the parameters of the learning model 22.

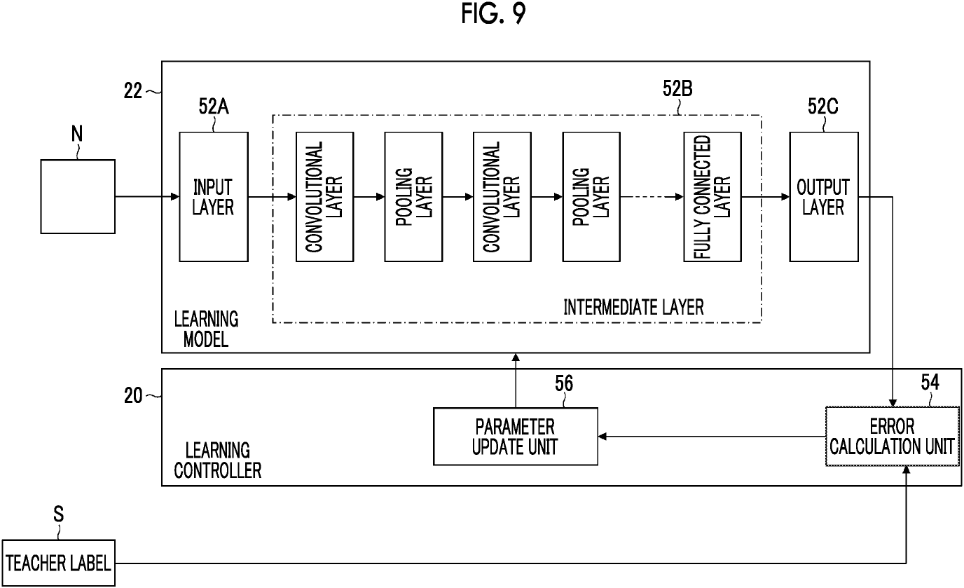

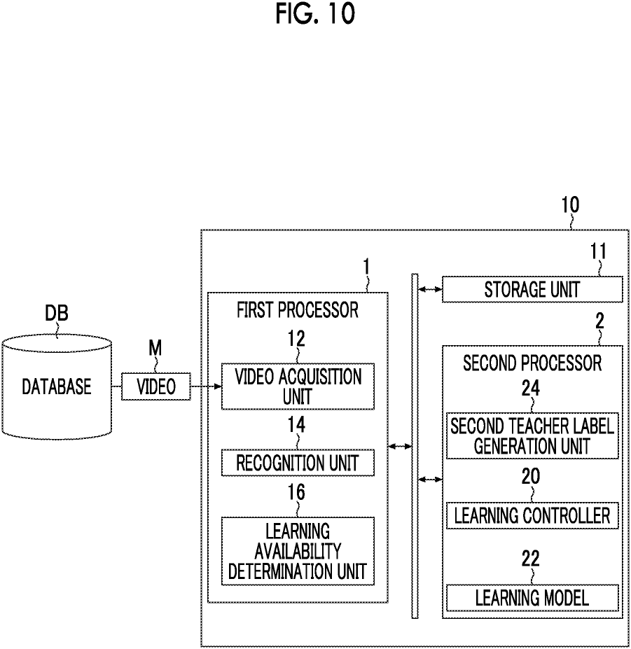

FIG. 9 is a functional block diagram showing the main functions of the learning controller 20 and the learning model 22. The learning controller 20 comprises an error calculation unit 54 and a parameter update unit 56. Further, a teacher label S is input to the learning controller 20.

In a case where machine learning is completed, the learning model 22 serves as a recognizer that recognizes the position of a region of interest (lesion) present in the image frame N and the type of the region of interest (lesion) from an image. The learning model 22 includes a plurality of layer structures, and holds a plurality of weight parameters. In a case where the weight parameters are updated to optimum values from initial values, the learning model 22 is changed into a trained model from an untrained model.

This learning model 22 comprises an input layer 52A, an interlayer 52B, and an output layer 52C. Each of the input layer 52A, the interlayer 52B, and the output layer 52C has a structure in which a plurality of “nodes” are connected by “edges”. A composite image C, which is an object to be learned, is input to the input layer 52A.

The interlayer 52B is a layer that extracts features from an image input from the input layer 52A. The interlayer 52B includes a plurality of sets, each of which is formed of a convolutional layer and a pooling layer, and a fully connected layer. The convolutional layer performs a convolution operation using a filter on nodes, which are present in a previous layer and are close to the convolutional layer, to acquire a feature map. The pooling layer reduces the feature map, which is output from the convolutional layer, to form a new feature map. The fully connected layer connects all the nodes of the previous layer (here, the pooling layer). The convolutional layer plays a role to extract features, such as to extract edges from an image, and the pooling layer plays a role to give robustness so that the extracted features are not affected by parallel translation or the like. The interlayer 52B is not limited to a case where the convolutional layer and the pooling layer form one set, and also includes a case where convolutional layers are consecutive and a normalization layer.

The output layer 52C is a layer that outputs the recognition results of the position and type of a region of interest present in the image frame N on the basis of the features extracted by the interlayer 52B.

The trained learning model 22 outputs the recognition results of the position of the region of interest and the type of the region of interest.

Arbitrary initial values are set for the coefficient of a filter applied to each convolutional layer of the untrained learning model 22, an offset value, and the weight of connection between the fully connected layer and the next layer.

The error calculation unit 54 acquires the recognition results output from the output layer 52C of the learning model 22 and teacher labels S corresponding to the image frames N, and calculates errors between both the recognition results and the teacher labels S. For example, softmax cross-entropy, a mean squared error (MSE), and the like are conceivable as a method of calculating the error. In a case where sample weights are given to the teacher labels, the error calculation unit 54 calculates errors on the basis of the sample weights.

The parameter update unit 56 adjusts the weight parameters of the learning model 22 by an error back propagation method on the basis of the errors calculated by the error calculation unit 54.

Processing for adjusting the parameters is repeatedly performed and learning is repeatedly performed until an error between the output of the learning model 22 and the teacher label S is small.

The learning controller 20 uses at least the data set of the image frame N and the teacher label S to optimize each parameter of the learning model 22. A mini-batch method including extracting a fixed number of data sets, performing the batch processing of machine learning using the extracted data sets, and repeating the extraction and the batch processing may be used for the learning of the learning controller 20.

In this embodiment, as described above, image frames N to be used as learning data are determined and teacher labels corresponding to the image frames N are generated on the basis of a given diagnosis result. Accordingly, in this embodiment, teacher labels can be generated by effectively using the given diagnosis result, and effective machine learning can be performed on the basis of the image frames N, which are determined to be used as learning data, and the teacher labels.

### Third Embodiment

Next, a third embodiment of the present invention will be described. In this embodiment, learning data are determined and teacher labels of image frames N, which are determined as the learning data, are generated on the basis of the distribution of recognition results of a plurality of recognizers.

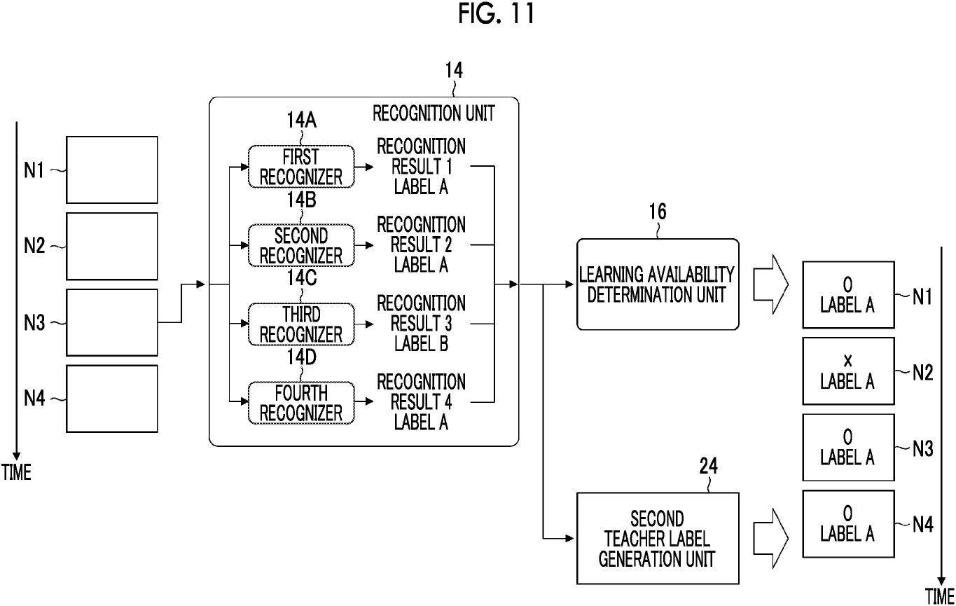

FIG. 10 is a block diagram showing the main configuration of an image processing device 10 according to this embodiment. Components already described will be denoted by the same reference numerals as described above and the description thereof will be omitted.

The image processing device 10 mainly comprises a first processor 1, a second processor (processor) 2, and a storage unit 11. The first processor 1 and the second processor 2 may be formed of the same CPUs (or GPUs) or may be formed of different CPUs (or GPUs). The first processor 1 and the second processor 2 realize the respective functions shown in a functional block by executing a program stored in the storage unit 11.

The first processor 1 includes a video acquisition unit 12, a recognition unit 14, and a learning availability determination unit 16. The second processor (processor) 2 includes a second teacher label generation unit 24, a learning controller 20, and a learning model 22.

The second teacher label generation unit 24 generates teacher labels for machine learning on the basis of the distribution of recognition results of a plurality of recognizers of the recognition unit 14.

The second teacher label generation unit 24 can generate teacher labels for machine learning by various methods on the basis of the distribution of recognition results of the plurality of recognizers. For example, the second teacher label generation unit 24 generates labels (major labels), which are output most in the recognition results, as teacher labels. Further, the second teacher label generation unit 24 may use the average value of scores, which are the recognition results of the plurality of recognizers, as a pseudo label. The second teacher label generation unit 24 can give sample weights to teacher labels to be generated. The second teacher label generation unit 24 can change sample weights, which are to be given to the teacher labels, according to the variation of the recognition results. For example, the second teacher label generation unit 24 increases a sample weight as the variation of the recognition result is smaller, and reduces a sample weight as the variation of the recognition result is larger. In a case where the variation of the recognition result is too large, a generated teacher label may not be used for machine learning.

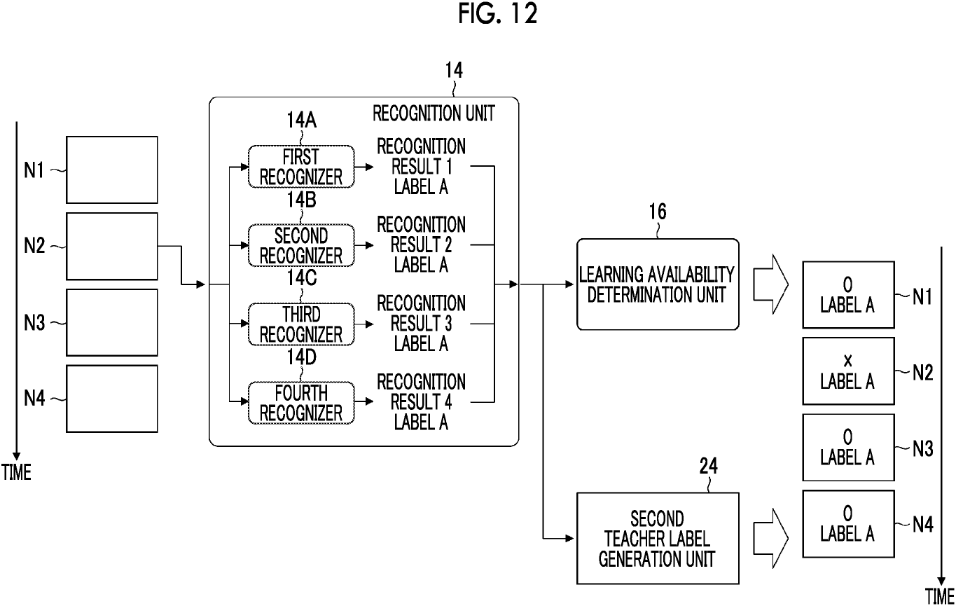

FIG. 11 is a diagram illustrating the learning availability determination unit 16 and the second teacher label generation unit 24. Components already described in FIG. 4 will be denoted by the same reference numerals as described above and the description thereof will be omitted.

Consecutive time-series image frames N1 to N4 are input to the recognition unit 14.

A case where the image frame N3 is input to the recognition unit 14 is shown in FIG. 11. The image frame N3 is determined to be used as learning data by the learning availability determination unit 16.

In a case where the image frame N3 is input to the recognition unit 14, recognition results 1 to 4 are output from first to fourth recognizers 14A to 14D. In a case where the image frame N3 is input, the first recognizer 14A outputs the recognition result 1 (label A). Further, in a case where the image frame N3 is input, the second recognizer 14B outputs the recognition result 2 (label A). Furthermore, in a case where the image frame N3 is input, the third recognizer 14C outputs the recognition result 3 (label B). Moreover, in a case where the image frame N3 is input, the fourth recognizer 14D outputs the recognition result 4 (label A). Since not all the recognition results 1 to 4 match, the learning availability determination unit 16 determines that the image frame N3 is used as learning data (“◯” is given to the image frame N3).

Further, as in the case of the above-mentioned image frame N3, the image frames N1 and N4 are also determined to be used as learning data (“◯” is given to the image frames N1 and N4).

Furthermore, the second teacher label generation unit 24 generates teacher labels on the basis of the distribution of the recognition results 1 to 4. Specifically, since the recognition result 1 is the label A, the recognition result 2 is the label A, the recognition result 3 is the label B, and the recognition result 4 is the label A, the recognition results are most distributed as the label A. Accordingly, the second teacher label generation unit 24 generates the labels A as teacher labels. Even in the cases of the image frames N1 and N4, as in the case of the image frame N3, the labels A are generated as teacher labels.

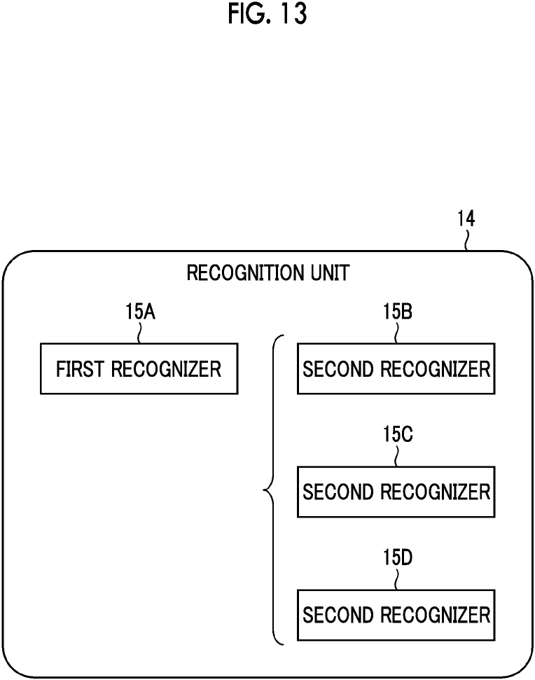

A case where the image frame N2 is input to the recognition unit 14 is shown in FIG. 12. The image frame N2 is determined not to be used as learning data by the learning availability determination unit 16.

In a case where the image frame N2 is input to the recognition unit 14, recognition results 1 to 4 are output from the first to fourth recognizers 14A to 14D. In a case where the image frame N2 is input, the first recognizer 14A outputs the recognition result 1 (label A). Further, in a case where the image frame N2 is input, the second recognizer 14B outputs the recognition result 2 (label A). Furthermore, in a case where the image frame N2 is input, the third recognizer 14C outputs the recognition result 3 (label A). Moreover, in a case where the image frame N2 is input, the fourth recognizer 14D outputs the recognition result 4 (label A). Since all the recognition results 1 to 4 match, the learning availability determination unit 16 determines that the image frame N2 is not used as learning data (“×” is given to the image frame N2).

In this embodiment, as described above, image frames N to be used as learning data are determined by the learning availability determination unit 16. Further, teacher labels are generated by the second teacher label generation unit 24 as described above. After that, as shown in FIG. 9, the image frames N are input to the learning model 22 and the teacher labels are input to the learning controller 20. The image frames N, which are determined to be used as learning data by the learning availability determination unit 16, are input to the learning model 22. Further, the teacher labels S generated by the second teacher label generation unit 24 are input to the learning controller 20. The learning controller 20 uses at least the data set of the image frame N and the teacher label S to optimize each parameter of the learning model 22.

As described above, in this embodiment, image frames N to be used as learning data are determined and teacher labels corresponding to the image frames N are generated on the basis of the distribution of recognition results. Accordingly, in this embodiment, since the teacher label can be generated on the basis of the recognition results even in a case where a diagnosis result of a medical doctor or the like is not given, effective machine learning can be performed on the basis of the image frames N, which are determined to be used as learning data, and the teacher labels.

### Modification Examples

Next, modification examples will be described. The following modification examples can be applied to the first to third embodiments described above.

### Modification Example of Recognition Unit

A modification example of the recognition unit 14 will be described. The example of the recognition unit 14 has been described in FIG. 3, but the recognition unit 14 is not limited thereto. The modification example of the recognition unit 14 will be described below.

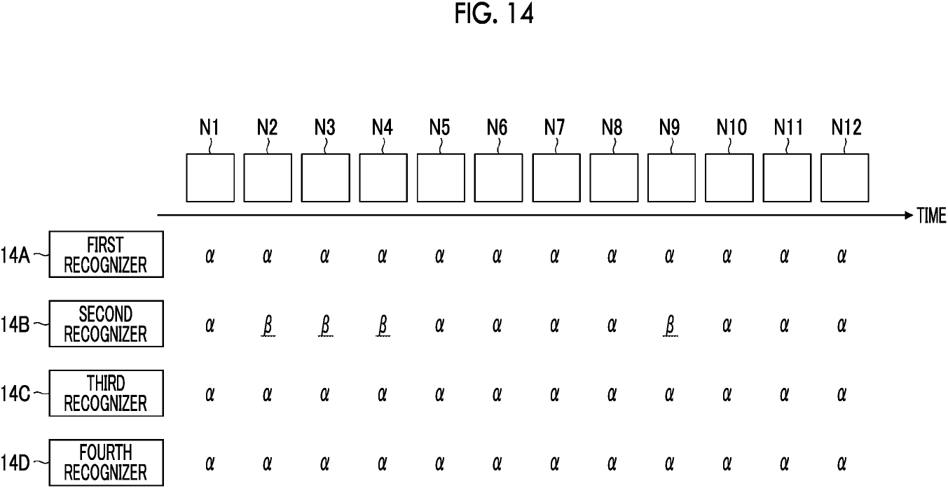

FIG. 13 is a diagram showing the modification example of the recognition unit 14.

The recognition unit 14 includes a first recognizer 15A, a second recognizer 15B, a second recognizer 15C, and a second recognizer 15D. The first recognizer 15A is formed of an average trained model (recognition model) that is directly used by a user and is common to each country. Further, each of the second recognizers 15B, 15C, and 15D is formed of a trained model that is trained with biased learning data. With such a configuration of the recognition unit 14, the image frames N to be used as learning data can be determined on the basis of average recognition results common to each country and biased recognition results.

### Learning Availability Determination Unit

Next, a modification example of the learning availability determination unit 16 will be described. The learning availability determination units 16 of the first to third embodiments have determined whether or not to use an image frame N as learning data according to the variations (distribution) of the recognition results of the first to fourth recognizers 14A to 14D for each image frame N. However, the learning availability determination unit 16 is not limited thereto. The modification example of the learning availability determination unit 16 will be described below.

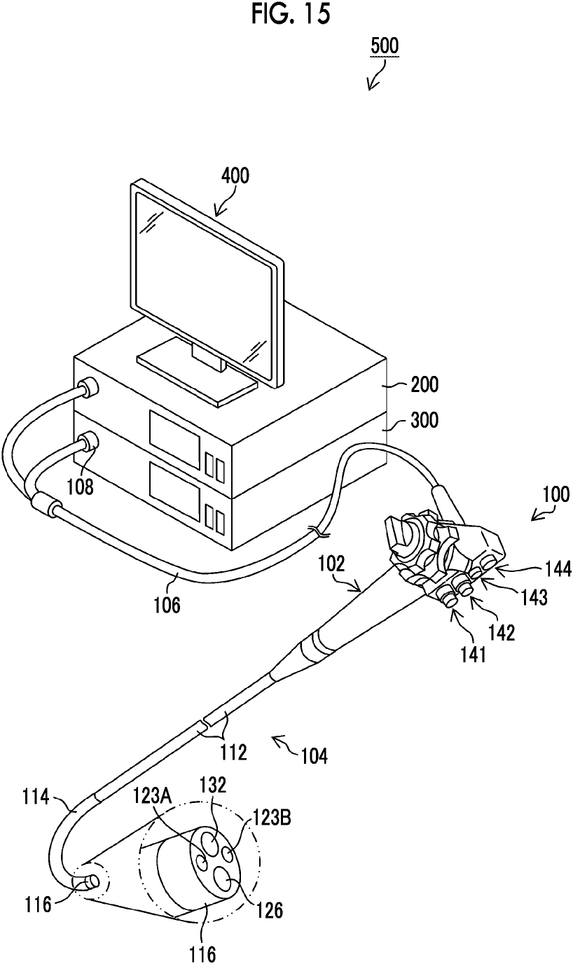

FIG. 14 is a diagram illustrating a modification example of the learning availability determination unit 16.

In this example, a plurality of recognizers are made to perform processing for recognizing a lesion in consecutive time-series image frames and consecutive time-series recognition results of each of the plurality of recognizers are acquired. FIG. 14 shows recognition results in a case where consecutive time-series image frames N1 to N12 are input to each of the first to fourth recognizers 14A to 14D.

The learning availability determination unit 16 determines whether or not to use the image frames for machine learning on the basis of the consecutive time-series recognition results of each of the plurality of recognizers.

The first recognizer 14A outputs recognition results α on the basis of the input image frames N1 to N12. Specifically, the first recognizer 14A outputs the recognition result α for each of the image frames N1 to N12. Further, the third and fourth recognizers 14C and 14D also outputs recognition results α on the basis of the input image frames N1 to N12 like the first recognizer 14A.

On the other hand, the second recognizer 14B outputs recognition results α and recognition results β for the input image frames N1 to N12. Specifically, the second recognizer 14B outputs recognition results α in a case where the image frame N1, the image frames N5 to N8, and the image frames N10 to N12 are input. Further, the second recognizer 14B outputs recognition results β in a case where the image frames N2 to N4 and the image frame N9 are input.

The learning availability determination unit 16 of this example determines whether or not to use the image frames as learning data also in consideration of consecutive time-series recognition results. Specifically, the recognition results β are consecutive for three image frames of the image frames N2 to N4. Since the recognition results vary in a certain number of image frames (the image frames N2 to N4), the variation of the recognition results is not an error and the image frames N2 to N4 can be presumed as learning data allowing effective learning to be performed. Accordingly, the learning availability determination unit 16 determines that the image frames N2 to N4 are used as learning data. On the other hand, since all the recognition results of the first to fourth recognizers 14A to 14D match in the previous frame and the later frame of the image frame N9 (the image frames N8 and N10), the variation of the recognition result in the image frame N9 can be presumed as an error. Accordingly, the learning availability determination unit 16 determines that the image frame N9 is not used as learning data.

According to the learning availability determination unit 16 of this example, as described above, it is determined whether or not to use the image frame N as learning data on the basis of not only the variation of the recognition result for each image frame N but also the variation of the time-series recognition results. Accordingly, it is possible to more effectively determine learning data that allow effective machine learning to be performed.

### Overall Configuration of Endoscope Apparatus

The examination video M used in the technique of the present disclosure is acquired by the endoscope apparatus (endoscope system) 500 to be described below, and is then stored in the database DB. The endoscope apparatus 500 to be described below is an example and an endoscope apparatus is not limited thereto.

FIG. 15 is a diagram illustrating overall configuration of the endoscope apparatus 500.

The endoscope apparatus 500 comprises an endoscope body 100, a processor device 200, a light source device 300, and a display device 400. A part of the hard distal end part 116 provided on the endoscope body 100 is enlarged and shown in FIG. 13.

The endoscope body 100 comprises a hand operation unit 102 and a scope 104. A user grips and operates the hand operation unit 102, inserts the insertion unit (scope) 104 into the body of an object to be examined, and observes the inside of the body of the object to be examined. A user is synonymous with a medical doctor, an operator, and the like. Further, the object to be examined mentioned here is synonymous with a patient and an examinee.

The hand operation unit 102 comprises an air/water supply button 141, a suction button 142, a function button 143, and an image pickup button 144. The air/water supply button 141 receives operations of an instruction to supply air and an instruction to supply water.

The suction button 142 receives a suction instruction. Various functions are assigned to the function button 143. The function button 143 receives instructions for various functions. The image pickup button 144 receives an image pickup instruction operation. Image pickup includes picking up a video and picking up a static image.

The scope (insertion unit) 104 comprises a soft part 112, a bendable part 114, and a hard distal end part 116. The soft part 112, the bendable part 114, and the hard distal end part 116 are arranged in the order of the soft part 112, the bendable part 114, and the hard distal end part 116 from the hand operation unit 102. That is, the bendable part 114 is connected to the proximal end side of the hard distal end part 116, the soft part 112 is connected to the proximal end side of the bendable part 114, and the hand operation unit 102 is connected to the proximal end side of the scope 104.

A user can operate the hand operation unit 102 to bend the bendable part 114 and to change the orientation of the hard distal end part 116 vertically and horizontally. The hard distal end part 116 comprises an image pickup unit, an illumination unit, and a forceps port 126.

An image pickup lens 132 of the image pickup unit is shown in FIG. 15. Further, an illumination lens 123A and an illumination lens 123B of the illumination unit are shown in FIG. 13. The image pickup unit is denoted by reference numeral 130 and is shown in FIG. 16. Furthermore, the illumination unit is denoted by reference numeral 123 and is shown in FIG. 16.

During an observation and a treatment, at least one of white light (normal light) or narrow-band light (special light) is output via the illumination lenses 123A and 123B according to the operation of an operation unit 208 shown in FIG. 16.

In a case where the air/water supply button 141 is operated, washing water is discharged from a water supply nozzle or gas is discharged from an air supply nozzle. The washing water and the gas are used to wash the illumination lens 123A and the like. The water supply nozzle and the air supply nozzle are not shown. The water supply nozzle and the air supply nozzle may be made common.

The forceps port 126 communicates with a pipe line. A treatment tool is inserted into the pipe line. A treatment tool is supported to be capable of appropriately moving forward and backward. In a case where a tumor or the like is to be removed, a treatment tool is applied and required treatment is performed. Reference numeral 106 shown in FIG. 15 denotes a universal cable. Reference numeral 108 denotes a light guide connector.

FIG. 16 is a functional block diagram of the endoscope apparatus 500. The endoscope body 100 comprises an image pickup unit 130. The image pickup unit 130 is disposed in the hard distal end part 116. The image pickup unit 130 comprises an image pickup lens 132, an image pickup element 134, a drive circuit 136, and an analog front end 138. AFE is an abbreviation for Analog front end.

The image pickup lens 132 is disposed on a distal end-side end surface 116A of the hard distal end part 116. The image pickup element 134 is disposed at a position on one side of the image pickup lens 132 opposite to the distal end-side end surface 116A. A CMOS type image sensor is applied as the image pickup element 134. A CCD type image sensor may be applied as the image pickup element 134. CMOS is an abbreviation for Complementary Metal-Oxide Semiconductor. CCD is an abbreviation for Charge Coupled Device.

A color image pickup element is applied as the image pickup element 134. Examples of a color image pickup element include an image pickup element that comprises color filters corresponding to RGB. RGB is the initial letters of red, green, and yellow written in English.

A monochrome image pickup element may be applied as the image pickup element 134. In a case where a monochrome image pickup element is applied as the image pickup element 134, the image pickup unit 130 may switch the wavelength range of the incident light of the image pickup element 134 to perform field-sequential or color-sequential image pickup.

The drive circuit 136 supplies various timing signals, which are required for the operation of the image pickup element 134, to image pickup element 134 on the basis of control signals transmitted from the processor device 200.

The analog front end 138 comprises an amplifier, a filter, and an AD converter. AD is the initial letters of analog and digital written in English. The analog front end 138 performs processing, such as amplification, noise rejection, and analog-to-digital conversion, on the output signals of the image pickup element 134. The output signals of the analog front end 138 are transmitted to the processor device 200. AFE shown in FIG. 16 is an abbreviation for Analog front end written in English.

An optical image of an object to be observed is formed on the light-receiving surface of the image pickup element 134 through the image pickup lens 132. The image pickup element 134 converts the optical image of the object to be observed into electrical signals. Electrical signals output from the image pickup element 134 are transmitted to the processor device 200 via a signal line.

The illumination unit 123 is disposed in the hard distal end part 116. The illumination unit 123 comprises an illumination lens 123A and an illumination lens 123B. The illumination lenses 123A and 123B are disposed on the distal end-side end surface 116A at positions adjacent to the image pickup lens 132.

The illumination unit 123 comprises a light guide 170. An emission end of the light guide 170 is disposed at a position on one side of the illumination lenses 123A and 123B opposite to the distal end-side end surface 116A.

The light guide 170 is inserted into the scope 104, the hand operation unit 102, and the universal cable 106 shown in FIG. 15. An incident end of the light guide 170 is disposed in the light guide connector 108.

The processor device 200 comprises an image input controller 202, an image pickup signal processing unit 204, and a video output unit 206. The image input controller 202 acquires electrical signals that are transmitted from the endoscope body 100 and correspond to the optical image of the object to be observed.

The image pickup signal processing unit 204 generates an endoscopic image and an examination video M of the object to be observed on the basis of image pickup signals that are the electrical signals corresponding to the optical image of the object to be observed.

The image pickup signal processing unit 204 may perform image quality correction in which digital signal processing, such as white balance processing and shading correction processing, is applied to the image pickup signals. The image pickup signal processing unit 204 may add accessory information, which is defined by the DICOM standard, to image frames forming an endoscopic image or an examination video M. DICOM is an abbreviation for Digital Imaging and Communications in Medicine.

The video output unit 206 transmits display signals, which represent an image generated using the image pickup signal processing unit 204, to the display device 400. The display device 400 displays the image of the object to be observed.

In a case where the image pickup button 144 shown in FIG. 15 is operated, the processor device 200 operates the image input controller 202, the image pickup signal processing unit 204, and the like in response to an image pickup command signal transmitted from the endoscope body 100.

In a case where the processor device 200 acquires a freeze command signal indicating the pickup of a static image from the endoscope body 100, the processor device 200 applies the image pickup signal processing unit 204 to generate a static image based on a frame image obtained at an operation timing of the image pickup button 144. The processor device 200 uses the display device 400 to display the static image.

The processor device 200 comprises a communication controller 205. The communication controller 205 controls communication with devices that are communicably connected via an in-hospital system, an in-hospital LAN, and the like. A communication protocol based on the DICOM standard may be applied as the communication controller 205. Examples of the in-hospital system include a hospital information system (HIS). LAN is an abbreviation for Local Area Network.

The processor device 200 comprises a storage unit 207. The storage unit 207 stores endoscopic images and examination videos M generated using the endoscope body 100. The storage unit 207 may store various types of information incidental to the endoscopic images and the examination videos M. Specifically, the storage unit 207 stores instructional information, such as operation logs in the pickup of the endoscopic images and the examination videos M. The instructional information, such as the endoscopic images, the examination videos M, and the operation logs stored in the storage unit 207, is stored in the database DB.

The processor device 200 comprises an operation unit 208. The operation unit 208 outputs a command signal corresponding to a user’s operation. A keyboard, a mouse, a joystick, and the like may be applied as the operation unit 208.

The processor device 200 comprises a voice processing unit 209 and a speaker 209A. The voice processing unit 209 generates voice signals that represent information notified as voice. The speaker 209A converts the voice signals, which are generated using the voice processing unit 209, into voice. Examples of voice output from the speaker 209A include a message, voice guidance, warning sound, and the like.

The processor device 200 comprises a CPU 210, a ROM 211, and a RAM 212. ROM is an abbreviation for Read Only Memory. RAM is an abbreviation for Random Access Memory.

The CPU 210 functions as an overall controller for the processor device 200. The CPU 210 functions as a memory controller that controls the ROM 211 and the RAM 212. Various programs, control parameters, and the like to be applied to the processor device 200 are stored in the ROM 211.

The RAM 212 is applied to a temporary storage area for data of various types of processing and a processing area for calculation processing using the CPU 210. The RAM 212 may be applied to a buffer memory in a case where an endoscopic image is acquired.

### Hardware Configuration of Processor Device

A computer may be applied as the processor device 200. The following hardware may be applied as the computer, and the computer may realize the function of the processor device 200 by executing a prescribed program. The program is synonymous with software.

In the processor device 200, various processors may be applied as a signal processing unit for performing signal processing. Examples of the processor include a CPU and a graphics processing unit (GPU). The CPU is a general-purpose processor that functions as a signal processing unit by executing a program. The GPU is a processor specialized in image processing. An electric circuit in which electric circuit elements such as semiconductor elements are combined is applied as the hardware of the processor. Each controller comprises a ROM in which programs and the like are stored and a RAM that is a work area or the like for various types of calculation.

Two or more processors may be applied to one signal processing unit. Two or more processors may be the same type of processors or may be different types of processors. Further, one processor may be applied to a plurality of signal processing units. The processor device 200 described in the embodiment corresponds to an example of an endoscope controller.

### Configuration Example of Light Source Device

The light source device 300 comprises a light source 310, a stop 330, a condenser lens 340, and a light source controller 350. The light source device 300 causes observation light to be incident on the light guide 170. The light source 310 comprises a red light source 310R, a green light source 310G, and a blue light source 310B. The red light source 310R, the green light source 310G, and the blue light source 310B emit red narrow-band light, green narrow-band light, and blue narrow-band light, respectively.

The light source 310 may generate illumination light in which red narrow-band light, green narrow-band light, and blue narrow-band light are arbitrarily combined. For example, the light source 310 may combine red narrow-band light, green narrow-band light, and blue narrow-band light to generate white light. Further, the light source 310 may combine arbitrary two of red narrow-band light, green narrow-band light, and blue narrow-band light to generate narrow-band light. Here, white light is light used for normal endoscopy and is called normal light, and narrow-band light is called special light.

The light source 310 may use arbitrary one of red narrow-band light, green narrow-band light, and blue narrow-band light to generate narrow-band light. The light source 310 may selectively switch and emit white light or narrow-band light. The light source 310 may comprise an infrared light source that emits infrared light, an ultraviolet light source that emits ultraviolet light, and the like.

The light source 310 may employ an aspect in which a light source comprises a white light source for emitting white light, a filter allowing white light to pass therethrough, and a filter allowing narrow-band light to pass therethrough. The light source 310 of such an aspect may switch the filter that allows white light to pass therethrough and the filter that allows narrow-band light to pass therethrough to selectively emit any one of white light or narrow-band light.

The filter that allows narrow-band light to pass therethrough may include a plurality of filters corresponding to different wavelength ranges. The light source 310 may selectively switch the plurality of filters, which corresponds to different wavelength ranges, to selectively emit a plurality of types of narrow-band light having different wavelength ranges.

The type, the wavelength range, and the like of the light source 310 may be applied depending on the type of an object to be observed, the purpose of observation, and the like. Examples of the type of the light source 310 include a laser light source, a xenon light source, a LED light source, and the like. LED is an abbreviation for Light-Emitting Diode.

In a case where the light guide connector 108 is connected to the light source device 300, observation light emitted from the light source 310 reaches the incident end of the light guide 170 via the stop 330 and the condenser lens 340. An object to be observed is irradiated with observation light via the light guide 170, the illumination lens 123A, and the like.

The light source controller 350 transmits control signals to the light source 310 and the stop 330 on the basis of the command signal transmitted from the processor device 200. The light source controller 350 controls the illuminance of observation light emitted from the light source 310, the switching of the observation light, ON/OFF of the observation light, and the like.

### Change of Light Source

In the endoscope apparatus 500, light of a white-light wavelength range or normal light, which is obtained in a case where light of a plurality of wavelength ranges is applied as light of a white-light wavelength range, can be used as a light source. On the other hand, the endoscope apparatus 500 also can apply light (special light) of a specific wavelength range. Specific examples of the specific wavelength range will be described below.

### First Example

A first example of the specific wavelength range is a blue-light wavelength range or a green-light wavelength range in a visible-light wavelength range. The wavelength range of the first example includes a wavelength range of 390 nm or more and 450 nm or less or a wavelength range of 530 nm or more and 550 nm or less, and light of the first example has a peak wavelength in a wavelength range of 390 nm or more and 450 nm or less or a wavelength range of 530 nm or more and 550 nm or less.

### Second Example

A second example of the specific wavelength range is a red-light wavelength range in a visible-light wavelength range. The wavelength range of the second example includes a wavelength range of 585 nm or more and 615 nm or less or a wavelength range of 610 nm or more and 730 nm or less, and light of the second example has a peak wavelength in a wavelength range of 585 nm or more and 615 nm or less or a wavelength range of 610 nm or more and 730 nm or less.

### Third Example

A third example of the specific wavelength range includes a wavelength range where a light absorption coefficient in oxygenated hemoglobin and a light absorption coefficient in reduced hemoglobin are different from each other, and light of the third example has a peak wavelength in a wavelength range where a light absorption coefficient in oxygenated hemoglobin and a light absorption coefficient in reduced hemoglobin are different from each other. The wavelength range of the third example includes a wavelength range of 400±10 nm, 440±10 nm, 470±10 nm, or 600 nm or more and 750 nm or less, and the light of the third example has a peak wavelength in a wavelength range of 400±10 nm, 440±10 nm, 470±10 nm, or 600 nm or more and 750 nm or less.

### Fourth Example

A fourth example of the specific wavelength range is the wavelength range of excitation light that is used for the observation of fluorescence emitted from a fluorescent material in a living body and excites the fluorescent material. The fourth example of the specific wavelength range is a wavelength range of, for example, 390 nm or more and 470 nm or less. The observation of fluorescence may be referred to as fluorescence observation.

### Fifth Example

A fifth example of the specific wavelength range is the wavelength range of infrared light. The wavelength range of the fifth example includes a wavelength range of 790 nm or more and 820 nm or less or 905 nm or more and 970 nm or less, and light of the fifth example has a peak wavelength in a wavelength range of 790 nm or more and 820 nm or less or 905 nm or more and 970 nm or less.

### Example of Generation of Special Light Image

The processor device 200 may generate a special light image, which has information about the specific wavelength range, on the basis of a normal light image that is picked up using white light. Generation mentioned here includes acquisition. In this case, the processor device 200 functions as a special light image-acquisition unit. Then, the processor device 200 obtains signals in the specific wavelength range by performing calculation based on color information of red, green and blue, or cyan, magenta, and yellow included in the normal light image. Cyan, magenta, and yellow may be expressed as CMY using the initial letters of cyan, magenta, and yellow written in English.

### Others

In the embodiments, the hardware structures of processing units (the first processor 1 and the second processor 2), which perform various types of processing, are various processors to be described below. The various processors include: a central processing unit (CPU) that is a general-purpose processor functioning as various processing units by executing software (program); a programmable logic device (PLD) that is a processor of which circuit configuration can be changed after manufacture, such as a field programmable gate array (FPGA); a dedicated electrical circuit that is a processor having circuit configuration designed exclusively to perform specific processing, such as an application specific integrated circuit (ASIC); and the like.

The first processor 1 and/or the second processor 2 may be formed of one of these various processors, or may be formed of two or more same type or different types of processors (for example, a plurality of FPGAs or a combination of a CPU and an FPGA). Further, a plurality of processing units may be formed of one processor. As an example where a plurality of processing units are formed of one processor, first, there is an aspect where one processor is formed of a combination of one or more CPUs and software as typified by a computer, such as a client or a server, and functions as a plurality of processing units. Second, there is an aspect where a processor implementing the functions of the entire system, which includes a plurality of processing units, by one integrated circuit (IC) chip is used as typified by System On Chip (SoC) or the like. In this way, various processing units are formed using one or more of the above-mentioned various processors as hardware structures.

In addition, the hardware structures of these various processors are more specifically electrical circuitry where circuit elements, such as semiconductor elements, are combined.

Each configuration and function having been described above can be appropriately realized by arbitrary hardware, arbitrary software, or a combination of both arbitrary hardware and arbitrary software. For example, the present invention can also be applied to a program that causes a computer to perform the above-mentioned processing steps (processing procedure), a computer-readable recording medium (non-transitory recording medium) in which such a program is recorded, or a computer in which such a program can be installed.

### Others

In the embodiments, the hardware structures of processing units (the first processor 1 and the second processor 2), which perform various types of processing, are various processors to be described below. The various processors include: a central processing unit (CPU) that is a general-purpose processor functioning as various processing units by executing software (program); a programmable logic device (PLD) that is a processor of which circuit configuration can be changed after manufacture, such as a field programmable gate array (FPGA); a dedicated electrical circuit that is a processor having circuit configuration designed exclusively to perform specific processing, such as an application specific integrated circuit (ASIC); and the like.

One processing unit may be formed of one of these various processors, or may be formed of two or more same type or different types of processors (for example, a plurality of FPGAs or a combination of a CPU and an FPGA). Further, a plurality of processing units may be formed of one processor. As an example where a plurality of processing units are formed of one processor, first, there is an aspect where one processor is formed of a combination of one or more CPUs and software as typified by a computer, such as a client or a server, and functions as a plurality of processing units. Second, there is an aspect where a processor implementing the functions of the entire system, which includes a plurality of processing units, by one integrated circuit (IC) chip is used as typified by System On Chip (SoC) or the like. In this way, various processing units are formed using one or more of the above-mentioned various processors as hardware structures.

In addition, the hardware structures of these various processors are more specifically electrical circuitry where circuit elements, such as semiconductor elements, are combined.

Each configuration and function having been described above can be appropriately realized by arbitrary hardware, arbitrary software, or a combination of both arbitrary hardware and arbitrary software. For example, the present invention can also be applied to a program that causes a computer to perform the above-mentioned processing steps (processing procedure), a computer-readable recording medium (non-transitory recording medium) in which such a program is recorded, or a computer in which such a program can be installed.

The embodiments of the present invention have been described above, but it goes without saying that the present invention is not limited to the above-mentioned embodiments and may have various modifications without departing from the scope of the present invention.

### EXPLANATION OF REFERENCES

1: first processor
2: second processor
10: image processing device
11: storage unit
12: video acquisition unit
14: recognition unit
14A: first recognizer
14B: second recognizer
14C: third recognizer
14D: fourth recognizer
16: learning availability determination unit
18: first teacher label generation unit
20: learning controller
22: learning model
24: second teacher label generation unit

What is claimed is:

1. An image processing device comprising:
a processor configured to:
acquire a video acquired by a medical apparatus;
perform processing for recognizing a lesion in image frames forming the video with a plurality of recognizers, to acquire a recognition result of each of the plurality of recognizers; and
determine whether or not to use the image frame as learning data to be used for machine learning on the basis of the recognition result of each of the plurality of recognizers.

2. The image processing device according to claim 1,
wherein the plurality of recognizers differ in terms of at least one of a structure, a type, or a parameter of the recognizer.

3. The image processing device according to claim 1,
wherein the plurality of recognizers are subjected to learning using different learning data, respectively.

4. The image processing device according to claim 3,
wherein the plurality of recognizers are subjected to machine learning using the different learning data that are obtained from different medical devices, respectively.

5. The image processing device according to claim 4,
wherein the plurality of recognizers are subjected to machine learning using the different learning data obtained from facilities of different countries or regions, respectively.

6. The image processing device according to claim 3,
wherein the plurality of recognizers are subjected to machine learning using the different learning data obtained under different image pickup conditions, respectively.

7. The image processing device according to claim 1,
wherein the processor is further configured to generate teacher labels of the learning data on the basis of the diagnosis result in a case where the processor determines an image frame to which a diagnosis result is given as learning data.

8. The image processing device according to claim 1,
wherein a learning model, which performs the machine learning, is subjected to learning using the learning data determined by the processor.

9. The image processing device according to claim 8,
wherein the processor is further configured to cause the learning model to learn the learning data with sample weights that are determined on the basis of distribution of the recognition results of the plurality of recognizers.

10. The image processing device according to claim 1,
wherein the processor is further configured to generate teacher labels of the machine learning on the basis of distribution of the recognition results.

11. The image processing device according to claim 10,
wherein the processor is further configured to change sample weights for the machine learning according to magnitudes of variations of the recognition results.

12. The image processing device according to claim 1,
wherein the processor is further configured to:
perform processing for recognizing a lesion in the consecutive time-series image frames with the plurality of recognizers, to acquire the recognition results of each of the plurality of recognizers; and
determine whether or not to use the image frames for the machine learning on the basis of the consecutive time-series recognition results of each of the plurality of recognizers.

13. The image processing device according to claim 1,
wherein the processor is further configured to:
output the recognition result of at least one recognizer of the plurality of recognizers during acquisition of the video and; and
output the recognition results of the other recognizers after a first time has passed from acquisition of the video.

14. An image processing method of an image processing device including a processor and a plurality of recognizers, comprising:
acquiring a video acquired by a medical apparatus;
performing processing for recognizing a lesion in image frames forming the video with a plurality of recognizers, to acquire a recognition result of each of the plurality of recognizers; and
determining whether or not to use the image frame as learning data to be used for machine learning on the basis of the recognition result of each of the plurality of recognizers.

15. A non-transitory, computer-readable tangible recording medium which records thereon a program for causing, when read by a computer, the computer to perform an image processing method using a plurality of recognizers, comprising
acquiring a video acquired by a medical apparatus,
performing processing for recognizing a lesion in image frames forming the video with a plurality of recognizers, to acquire a recognition result of each of the plurality of recognizers, and
determining whether or not to use the image frame as learning data to be used for machine learning on the basis of the recognition result of each of the plurality of recognizers.
